(19) United States
(12) Patent Application Publication
(10) Pub. No.: US 2013/0144563 A1
(43) Pub. Date: Jun. 6, 2013

(54) Radiation Sensor

(71) Applicants: Stefan Naumann, Dreieich (DE); Fred Plotz, Taunusstein (DE); Arthur Barlow, Alton, NH (US); Hermann Karagozoglu, Wiesbaden (DE); Guido Lauck, Bingen (DE)

(72) Inventors: Stefan Naumann, Dreieich (DE); Fred Plotz, Taunusstein (DE); Arthur Barlow, Alton, NH (US); Hermann Karagozoglu, Wiesbaden (DE); Guido Lauck, Bingen (DE)

(73) Assignee: Excelitas Technologies GmbH & Co., KG, Wiesbaden (DE)

(21) Appl. No.: 13/637,598

(22) PCT Filed: Mar. 24, 2011
(86) PCT No.: PCT/EP2011/001489

§ 371 Date: Oct. 17, 2012

(30) Foreign Application Priority Data
Apr. 1, 2010 (DE) 10 2010 013 663.8

(51) Int. Cl. G01J 5/08; G01J 1/04

(52) U.S. Cl. CPC G01J 5/0803; G01J 1/04
USPC 702/190; 250/208.2; 250/349

(57) ABSTRACT

A radiation sensor (10) comprises plural radiation sensing elements (1) arranged along an arrangement line, a lens having an optical axis focusing radiation towards the sensing elements, and circuitry (2) receiving the electric signal of the sensing elements and providing an output signal. The midpoint of the arrangement line may be offset against the optical axis of the converging section (5). At least some of the sensing elements may have different sizes. At least some of the sensing elements may have different relative sensitivity compared to each other. Two or more pairs of adjacent sensing elements may have a different pitch.

The invention relates to a radiation sensor according to the preamble of the independent claim. Such a radiation sensor is known from DE 19735379 and from DE 10 2004 028022.

Radiation sensors convert incident radiation into electrical signals for detection. The detection may be of qualitative or quantitative nature.

Qualitative detection is, for example, motion detection within the field of view of the sensor. Quantitative detection may be thermometry for temperature detection, e.g. measuring temperature of the human body.

One or more sensing elements in the sensor convert radiation into electrical signals and shape and format them appropriately. Since usually the incident signals are very weak, shaping includes usually at least amplification and/or impedance conversion. Filtering may also be made. Such shaped signals are output for further processing for accomplishing the desired qualitative or quantitative detection. Qualitative detection may comprise a radiation-dependent-intensity—threshold comparison. Quantitative detection may comprise a radiation-dependent-intensity—temperature-signal conversion.

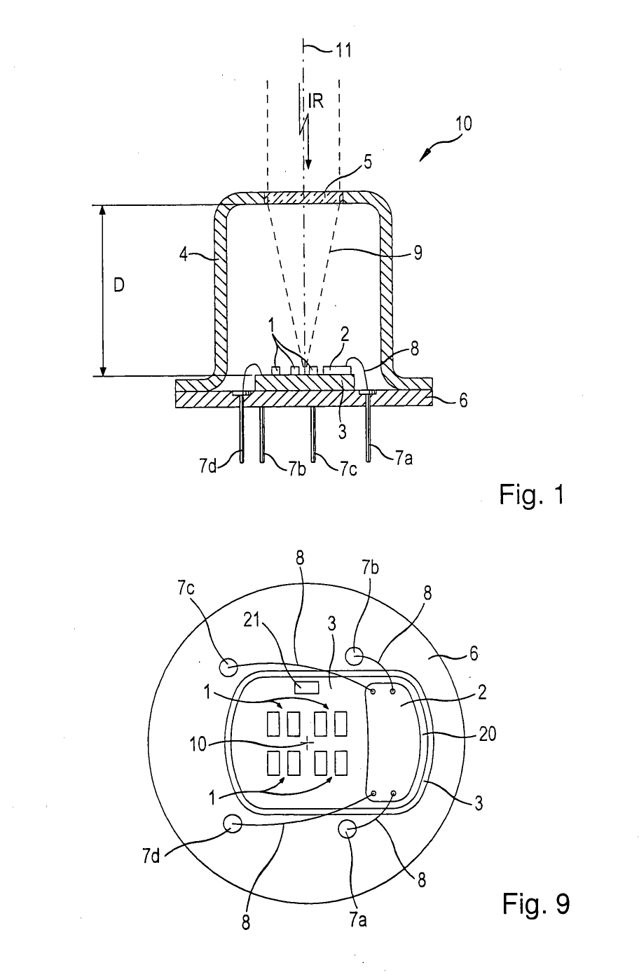

FIG. 1 shows a typical construction of a sensor 10 in side-cut view. The radiation to be measured is often infrared radiation with a maximum of sensitivity in a wavelength region above 1 μm. In FIG. 1, 1 designates plural sensing elements outputting independent of each other electric output signals in dependence of the respectively incident radiation. The incident radiation is symbolized by beam 9. Falling onto the sensor 10 it may be assumed to be parallel radiation because the radiation source is usually remote compared to the sensor dimension. Beam converging means 5, for example provided as a part of the overall housing 4-6, converge the radiation onto the sensing element 1. Converging may be focussing, and the sensing elements 1 lay in the focal plane. The beam converging means 5 may be a lens, particularly a spherical lens with an optical axis parallel to, or coinciding with, an axis of the housing. 11 indicates an axis that is an optical axis of the converging means 5, coinciding with a symmetry axis of the housing cup 4 which may be of generally tubular shape.

There is also provided some kind of circuitry 2 receiving signals from the sensing element 1. The sensor further has terminals 7 which may include power terminals for power supply to the electric components within the sensor, and input and output terminals for inputting control signals and outputting signals in dependence of the incident radiation.

Often, resolution in space is desired within the field of view of the sensor. The sensor then has some kind of beam shaping elements, for example some kind of lens or mirror in its housing for converging or focussing incident radiation onto sensing elements.

Plural sensing elements may be provided so that depending on which of them receives converged or focussed radiation, one particular sensing element outputs a signal so that one may infer spatial information from the different outputs of the respective sensing elements.

Sensors have a certain field of view. The field of view is defined by housing properties, imaging properties of optical elements and by the sensor element arrangement. In known sensors, the arrangement is usually symmetrical or rectangular. FIG. 1 schematically shows an optical element 5 with a housing symmetry axis perpendicular to the surface on which one or more sensing elements are provided and coinciding with the optical axis of optical element 5. Usually, the sensing elements are provided symmetrically with respect to the optical axis. The optical element 5 itself is mounted and shaped symmetrically with respect to the components defining the sensor mounting, particularly base plate 6 (plane of optical element 5 parallel to plane 6).

The symmetry of the optical element and of the housing is usually a rotational symmetry. However, the mounting of the sensor with respect to the desired field of view is very often asymmetric. For example, in motion and presence detection, a device is mounted somewhat remote from the space to be monitored. For example, it may be mounted under a ceiling and may “look forward” several meters. The detection region is not right below the sensor and, thus, has an overall asymmetric appearance. To some extent, such asymmetric mounting conditions can be accommodated by tilting the sensor or the device that comprises the sensor. Then, still, asymmetries remain, these asymmetries leading to non-uniform detection properties depending on the distance from the sensor.

It is the object of the invention to provide a sensor adapted to an asymmetric field of view. It is a further object of the invention to provide a sensor having in an asymmetric mounting condition or an asymmetric field of view an improved uniformity of outputs of sensing elements. It is a further object of the invention to provide a sensor having in an asymmetric mounting condition or an asymmetric field of view an increased uniformity of viewing sectors.

These objects are accomplished by the features of the independent claims. Dependent claims are directed on preferred embodiments of the invention.

According to the invention, some tilt may already be built into the sensor by providing an asymmetric or offset arrangement of sensing elements as compared to the optical axis of the radiation converging means and/or by providing an asymmetric or offset arrangement of sensing elements as compared to the axis or center of the sensor housing and/or by providing one or more optical bending sections for bending the overall optical path.

Besides that, for equalizing differing sensitivities of plural sensing elements amongst each other, the plural sensing elements may have different sensitivities, different sizes, different pitches or different influencing layers.

Plural sensing elements of a sensor may be arranged along a—straight or bent—arrangement line which may be offset against the optical axis of a converging means or against an axis or center of the sensor housing. Particularly, the midpoint of the arrangement line may be offset against the optical axis or against the housing axis or housing center. The optical axis may or may not intersect the arrangement line.

Some of the sensing elements may have different sizes compared to each other. Particularly, they may have different lengths of their effective sensitive area in a direction along the arrangement line mentioned above.

Some of the sensing elements may have different relative sensitivities compared to each other. The different sensitivities may come from the inherent construction or may come from differently providing influencing layers (absorbing layers, reflecting layers) for influencing absorption or reflection of incident radiation.

The pitches of adjacent sensing elements may be different when comparing different pairs of adjacent sensing elements.

The optical system guiding radiation from outside towards the sensing elements may have a bending section for bending the overall radiation in addition to a potentially provided converging effect.

The above-mentioned measures may be taken respectively each for it alone, or may be taken in any combination thereof.

In the following, embodiments of the invention are described with reference to the attached drawings, in which

FIG. 1 is a sectional view of a sensor to which the invention may be applied,

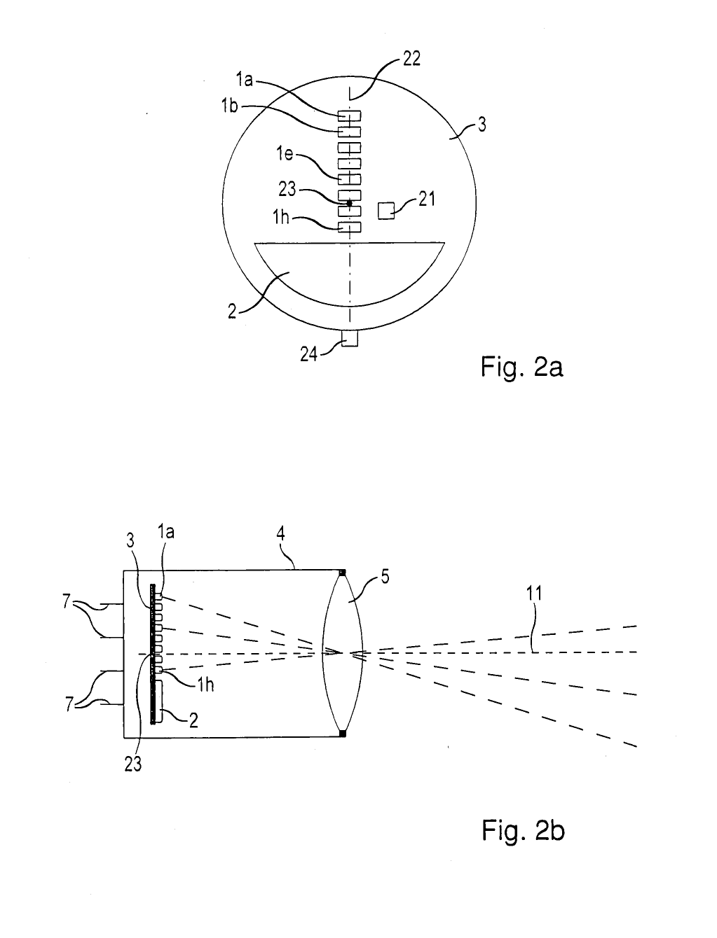

FIG. 2 shows a plan view of an arrangement of sensing elements in a sensor,

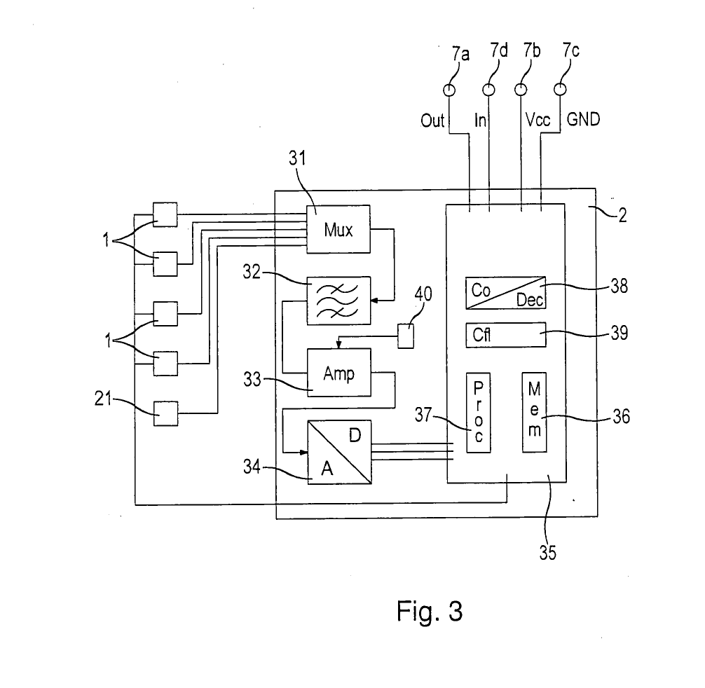

FIG. 3 is a block circuit diagram of the internal signal processing of the sensor,

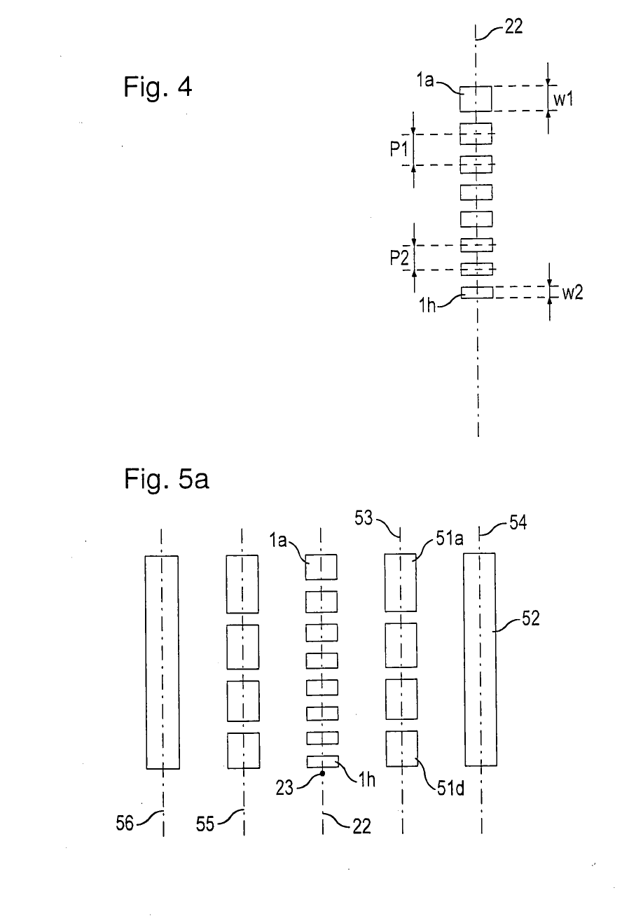

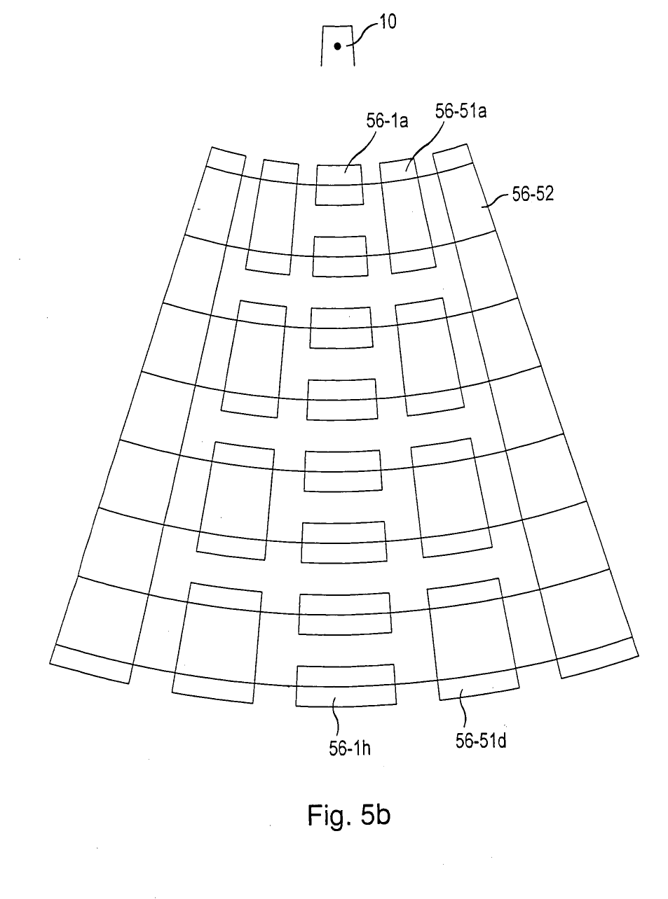

FIGS. 4 and 5a, b show dimensions and other arrangements of the sensing elements in a sensor and their projection on an area to be monitored,

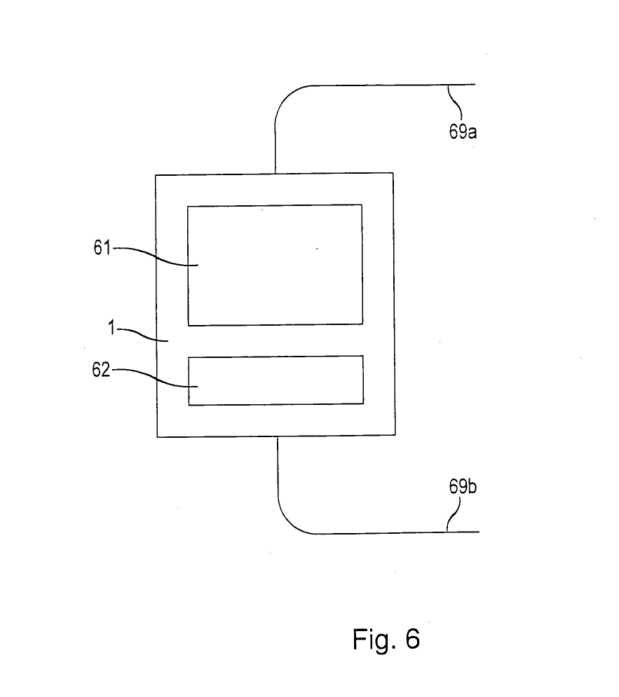

FIG. 6 shows a sensing element comprising influencing layers,

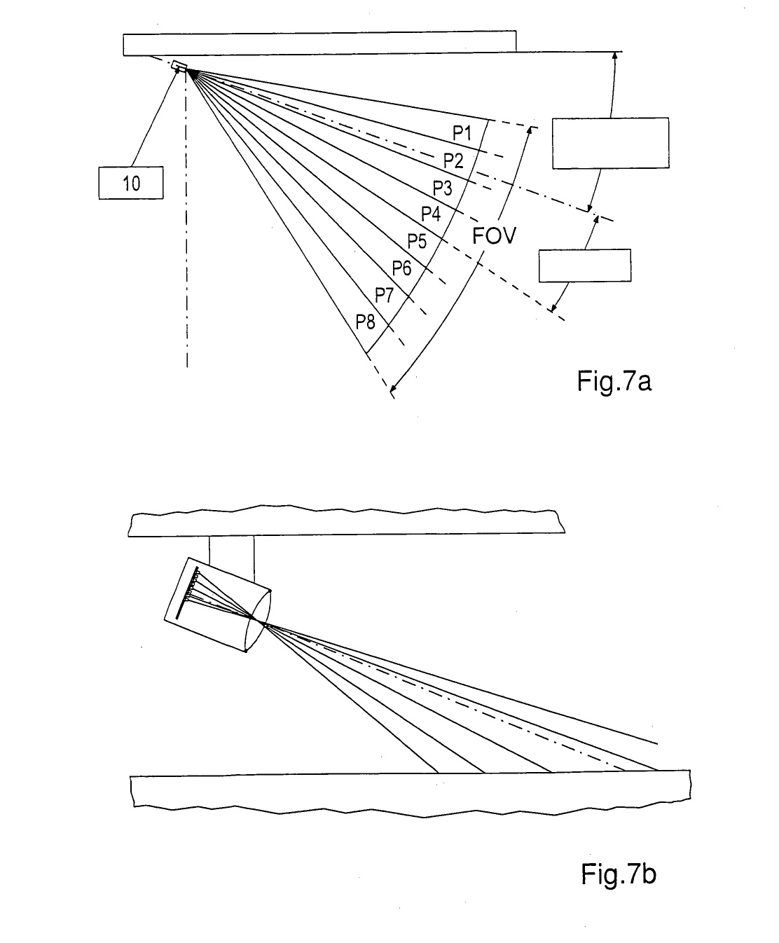

FIG. 7 shows geometrical considerations,

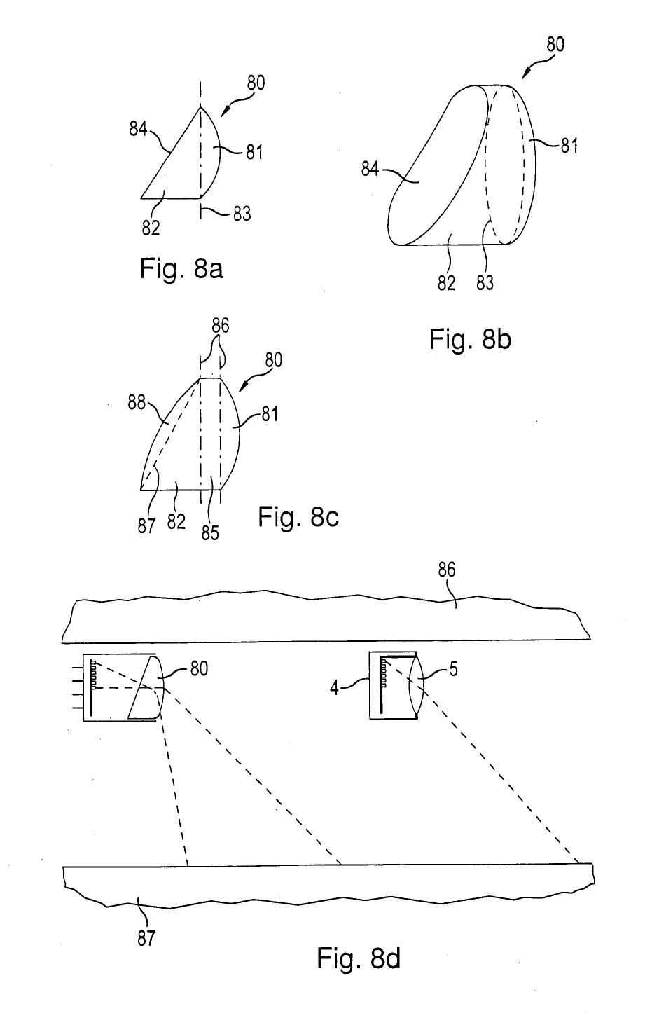

FIG. 8 a-d show an embodiment of a converging means, and

FIG. 9 shows a plane view on the internal constructions of the sensor.

FIG. 2 shows an arrangement of sensing elements in a sensor. The Figure is a plan view onto the base plate of the sensor and schematically shows the arrangement of plural sensing elements in relation to the base plate. It is pointed out that other structures may be provided in addition to those shown in FIG. 2, for example another substrate provided on the base plate and carrying the sensing elements 1. Likewise, a circuit board may also be provided carrying a substrate or the sensing elements directly.

Numerals 1a-1h indicate sensing elements. Altogether, eight sensing elements are shown arranged along an arrangement line schematically indicated by 22. It is pointed out that structure 22 is depicted only in the drawing of FIG. 2. In real products, it will most likely only be recognizable from the arrangement of the sensing elements 1. In the shown embodiment, the arrangement line 22 is a straight line. Likewise it may be bent. FIG. 2 shows that the arrangement of the sensing elements is asymmetric with respect to the center of the base plate. 23 indicates the mid point of the base plate or the center of the internal sensor cross section (point of gravity) in the arrangement plane of the sensing elements. It may be the intersection point of a housing axis with said arrangement plane. However, it may likewise indicate where the optical axis of the converging means 5 (lens, Fresnel lens) intersects the base plate/circuit board/substrate carrying the sensing elements 1. The arrangement of the sensing elements is asymmetric with respect to this point 23 (intersection point, midpoint). When the overall arrangement of the sensor housing and converging means 5 is symmetrical (circular symmetry), the midpoint of the housing and the intersection point of the optical axis with the base plate/circuit board/substrate may coincide. Thus, the midpoint of the arrangement line 22 of the sensing elements (8 shown in the embodiment of FIG. 2) may be offset against the sensor housing midpoint or optical axis, indicated by 23.

The effect of the arrangement is that the field of view of the sensor is no longer symmetric with respect to the optical axis of the converging means or the housing axis, which may coincide with the mechanical axis of the overall sensor. So, some kind of tilt is built into the sensor so that a mechanical tilt may be less or may completely be avoided. Accordingly, mounting the sensor built in this way is easier.

The sensing elements may be arranged such that on both sides of the point 23 different numbers of sensing elements are provided. The arrangement may be such that, on the one side thereof, no sensing element at all is provided. The arrangement may be such that the arrangement line intersects the optical axis. This is shown in FIG. 2. However, likewise, the arrangement may also be sideways offset against the optical axis so that the optical axis or housing axis does not intersect the arrangement line. Then, the arrangement line 22 is sideways offset against point 23.

The effect of the arrangement is that the field of view of the sensor is similarly offset against the optical axis as is the arrangement of the sensing elements. This is schematically shown in FIG. 2b. 21 symbolizes the optical axis, and four sensing elements 1a to 1d are shown arranged on the upper side of the optical axis 11. Through the imaging properties of the converging means 5 the fields of view of the respective sensing elements 1a to 1d are, on the other side of the converging means 5, arranged on the other side of the optical axis 11 (i.e. on the lower side in FIG. 2b). Assuming FIG. 2b being a schematic side view of a real mounting situation of a sensor below a ceiling, one recognizes that, although the sensor 10 is regularly mounted (major surfaces parallel or perpendicular to surrounding structures such as overall device or mounting wall), the sensor already “looks somewhat downward” due to the offset arrangement of the sensing elements compared to the optical axis 11.

In FIG. 2a, reference numeral 2 indicates circuitry for evaluating the signals from the sensing elements and for forming output signals. 21 may be a temperature sensor for measuring a reference temperature to be considered when evaluating the signals from the sensing elements. 24 may be a position-indicating structure for indicating the posture of the sensor. It may be a tangible structure at the outside of the sensor housing, e.g. some kind of protrusion or indentation, or it may be a graphic marking. The circuitry 2 will be described later with reference to FIG. 9.

FIG. 4 shows other features of the invention. Again, sensor elements 1a to 1h are shown arranged along an arrangement line 22. What is shown in combination is that

sensing elements 1 may have different sizes, particularly different widths, particularly in a direction along the arrangement line, in that sensing element 1a has a width w1 larger than another sensing element further down having a width 2,

different pairs of adjacent sensing elements have different pitches (step widths) in that the uppermost sensing elements have a larger pitch P1, whereas lower sensing elements have a smaller pitch P2.

Assuming FIG. 4 being a plan view on a sensor as mounted in real operation (i.e. ceiling being above sensing element 1a, floor being way below sensing element 1h, arrangement line 22 being vertical), through the inverting effect of the imaging converging means 5 the uppermost sensing elements will look to a nearer region, whereas the lowermost sensing elements will look to a more remote portion. Accordingly, they will project differently in these spaced areas, and particularly through the increasingly intersecting cut the remote regions will become wider in a radial direction, if sensing elements same-sized and same-pitched along the arrangement line are used. For compensating this, the remote looking sensing elements (lower sensing elements) are smaller and/or have a smaller pitch than have the near looking sensing elements.

Sensitivity adjustment of individual sensing elements may also be accomplished by a defocused placement of the respective sensing elements 1 in vertical direction (FIG. 1, z direction). Thus, differet sensing elements may have different z positions.

When sensing elements have different sizes along an arrangement line, they may decrease from top to bottom seen in mounting orientation, or they may decrease from an outermost sensing element towards the midpoint 23. When the sensitivities of sensing elements are different among each other, they may be made such that they compensate differing sensing outputs due to geometrical or optical properties. The pitch may decrease from a topmost sensing element in a downward direction, or may decrease from a peripheral area towards the center of the sensor.

FIG. 5a shows an arrangement along plural arrangement lines 22, 53-56. The middle one 22 may be the one that intersects with the optical axis or a symmetry axis of the sensor, which is symbolized by numeral 23 as above. Here, an embodiment where all sensing elements on an arrangement line are provided on one side of centre 23 is shown. In parallel to arrangement line 22, there may be provided one, two or more arrangement lines. Four are shown in FIG. 5a. Along these arrangement lines, further sensing elements 51, 52 may be arranged. In a vertical direction (i.e. a direction along a straight arrangement line), they may have the same arrangement pattern of sensing elements as has the centre line 22 or as the line described above. But likewise, as shown, the arrangement pattern of sensing elements may be different, e.g. having a lower number of sensing elements. If an even number of arrangement lines is provided (2, 4, 6, . . . ), the point 23 may fall right between two of them.

FIG. 5b shows how sensing elements may project onto an area to be monitored. It is a plan view onto a monitoring area. 10 is assumed to be a sensor having a sensing element pattern of FIG. 5a. 57 are individual areas imaged by the converging means 5 on particular ones of the sensing elements 1. Nearby regions 57-1a project onto the top sensing elements 1a, and vice versa. So, a radial movement translates into a projection along one of said arrangement lines, whereas a circumferential movement translates into a projection perpendicular to arrangement lines. The figure shows the respective regions with sharp contours. This is only schematic. The regions are not sharply defined.

FIG. 6 shows a technique of influencing the sensitivity of a particular sensing element 1. On top of all or a part of a sensing element (i.e. on the radiation incidence surface), an absorption layer 61 or a reflection layer 62 may be provided as a part of the sensing element. An absorption layer 61 increases infrared absorption and, thus, serves to maximize radiation/heat conversion leading to the generation of an electric signal. A reflection layer 62 accomplishes the opposite, namely minimizing the absorption and, thus, decreasing the sensitivity. The absorption layer 61 and the reflection layer 62 are shown on one sensing element 1 only for clarification. Usually absorption layers 61 are used, whereas reflection layers are not found that often, and particularly not in combination with absorption layers on the same sensing element.

According to a feature of the invention, differing sensing elements have different sensitivities. This can be used for compensating differing incoming radiation properties. Various effects make detection of remote and nearby targets unequal. Assuming two identical radiation sources, one of them remote and the other of them nearby, the remote one will radiate less radiation towards the sensor because the relative aperture of the sensing element is smaller the more remote the radiator is. This leads to the effect that targets, when they are in a remote field of view of the sensor, will lead to a relatively weak signal, compared to targets being in a near field of view. Depending on the arrangement, a compensating effect may be that, due to secondary optical effects, regions remote from the optical axis will have worse focussing properties and, thus, lead to worse radiation collection on a respective sensing element. This may affect nearby targets in a nearby field of view more than remote targets and may thus lead to a reduced sensitivity for nearby targets. The above-mentioned effects may cancel out to some extent depending on geometry, construction and fields of view. However, it is unlikely that they fully compensate each other, and a remaining inequality in sensitivities may be equalized by making sensitivity of the sensing elements unequal, e.g. by using influencing layers, particularly absorption layers 61 on those sensing elements found to give a weaker response. Sensing elements with a strong response may not have absorption layers, or may even have a reflection layer.

However, instead of using influencing layers, the different sensitivities of different sensing elements 1 may also be accomplished by different constructions, for example a different number of thermo-sensitive, series-connected contacts, or the like. Sensitivity adjustment of individual sensing elements may also be accomplished by a defocused placement of the respective sensing elements 1 in vertical direction (FIG. 1, z direction). Thus, all the sensing elements need not have the same placement with respect to the focal plane. Different sensing elements may have different z positions. And likewise, sensitivity adjustment of individual sensing elements may also be accomplished numerically in the digital part by applying different weighting factors to the different signals from the different sensing elements.

FIGS. 7 shows schematically a mounting situation in a side view. The sensor is designed as above. The field of view is offset against axis 11 to look more downward than the sensor housing or optical axis pointing downward. The lines indicate projections onto the sensing elements 1. One recognizes that the more remote they look, the more downward they project onto the sensing elements in the shown arrangement.

The sensor may comprise an optical element or structure that bends the optical path such that radiation outside the sensor element follows a path that is bent as compared to the path inside the sensor. In other words, the optical axes inside and outside the sensor are not parallel but include a certain angle. This may, for example, be accomplished by providing a prism-like optical structure in the optical path. It may be provided integrally with a lens or converging means. FIGS. 8a to 8d show embodiments 80 thereof.

FIG. 8a is a sectional view of an integrally formed converging means 80 consisting of a lens section 81 and a prism section 82, where the two sections are formed integrally. They may be shaped as an overall circular device as schematically shown in the perspective view of FIG. 8b. As such, it may be put into the front opening of a sensor or may be attached into a tubular housing structure of a sensor housing. The dashed line 83 symbolizes the virtual border between lens section 81 and prism section 82. 84 may be a plane surface of the prism section, facing the sensing elements. If used together with an asymmetric arrangement as shown in FIG. 2a, the thick part of the prism (bottom part in FIGS. 8a and 8b) may face the short side of the arrangement line, i.e. the side of the arrangement line with few or no sensing elements thereon. Then, the asymmetric arrangement of the sensing elements provides a first component of looking downward, and the additional provision of a prismatic section 82 provides a second component thereof. FIG. 8b shows this embodiment of the overall optical element 80 in a schematic perspective view.

FIG. 8c shows additional options of the optical element. Both sides of the prism section 82 may have spherical surfaces 81, 88, i.e. surfaces having a focussing effect. This is shown by reference numerals 81 (as also shown in FIG. 8a) and numeral 88 which is a lens section provided in addition to the prism section 82, separated by virtual separation line 86, 87. Besides that, a kind of plate section 85 may be provided between lens section 81 and prism section 82. Numeral 86 shows the virtual separation lines between the respective sections. As said above, the lens section(s) and the prism section may be formed integrally. However, likewise, they may be formed as individual components.

One recognizes that the bundle of optical paths for the respective sensing elements inside the sensor has an axis of symmetry different from that of the bundle outside the sensor. The bending is accomplished by the prism section of the optical system and by the sensing elements being arranged asymmetrically with respect to the sensor housing in that the majority is offset towards the top part of the housing. This provides the effect already described with reference to FIG. 2b, so that this effect and the prism effect add up to a sensor clearly “looking downward”, as shown in the schematic side view on the left side of FIG. 8d.

The material for forming the mentioned converging means 5, 80 may be silicon or germanium or other IR transparent material. These materials are infrared-transparent.

The right side of FIG. 8d shows further possibilities of adapting the sensor appearance to mounting conditions. Terminals and optical elements are provided on adjacent surfaces. There, terminals are provided on a sensor surface adjacent to a surface bearing the radiation inlet/optical element 5 or 80. The optical element may be designed as mentioned above. Likewise, the sensing elements 1 may be arranged as mentioned above. In many embodiments, the sensor may have an overall tubular appearance, with radiation inlet and terminals provided on opposing flat sides of the tubular body. In the right side FIG. 8d embodiment, however, the outer appearance may be closer to a rectangular or cube-like shape. There, the terminals sit in a region between sensing elements la to id and optical element 5.

The mentioned design options yield a sensor with a field of view that is asymmetric with respect to its outer appearance. This allows an easy handling and mounting of the sensor or of a device including the sensor and still having asymmetric properties of the field of view provided by the sensor or the device comprising the sensor.

In order to derive information on location and/or approximation of an IR emitting subject/object the array of vertical pixels can be combined with a horizontal line of multiple focussing elements to sense motion in a horizontal plane, such as a Fresnel lens having segments arranged next to each other along a line inclined with respect to, or perpendicular to, the arrangement line of the sensing. elements. The segments may slightly deviate in their external optical axis so that they “look” into different segments of the space to be monitored, seen in a plane (top) view. A typical common use Fresnel-lens has three vertical zones (“stacked” in vertical direction) and multiple (typically 8 to 12) horizontal ones (juxtaposed in horizontal direction). By such a lens, a zone pattern is generated for each pixel. Reading the individual pixels with appropriate frame-rate allows locating and follow the thermal pattern of an

IR emitting object through the detection range of the sensor allowing the accomplishment of a 2-D-Thermal image with a rather low number of sensitive elements or focusing elements.

In the following description is made of a second invention of the same applicant in the same technical field. It was filed separately on the same day as the present application. Features of the following second invention may be combined with the features of the invention described above.

Known sensors suffer also from the disadvantage that their output signals are affected by noise and thus do not precisely reflect the situation to be detected, and are complicated to use and thus require further external processing. Insofar, there exists an objective of providing a sensor for radiation providing a correct and easy to use output signal, which is accomplished by the features of below item 1. Dependent items are directed on preferred embodiments of the invention.

Insofar, a radiation sensor comprises one or more radiation sensing elements and circuitry receiving the electric signal of the sensing elements and providing a sensor output signal in accordance with the electric signal of the sensing element. The circuitry comprises either a switching signal circuitry for generating an on/off output signal for a switchable component extra known to the sensor, or comprises a digital output signal circuitry for providing a multiple bit serial output signal. The sensor further has one, preferably only one output terminal for outputting the on/off output signal or the multiple bit serial output signal.

With the mentioned features, the output signal is easy to use because it is output by the sensor in a “ready-to-use” format. Providing only one output terminal reduces affection of internal components by external noise because all together few terminals are provided which collect only low amounts of external noise.

The circuitry provided inside the sensor housing may be designed to have a power consumption of less than 50 μW, preferably smaller than 20 μW or smaller than 10 μW. The consumed power is converted into heat, and thus heating power inside the sensor is below the mentioned values so that internal heating up and thus internally generated sensing distortions are kept small and on a negligible level.

A temperature reference element may be provided for measuring the temperature of relevant parts of the sensor for considering it in signal evaluation.

The sensing elements may be thermopiles, bolometers or pyroelectric sensing elements. They may be provided pair-wise for common mode suppression. Plural sensing elements may be provided as an array (longitudinal arrangement) or as a matrix (covering a certain area) for allowing spatial resolution.

The sensing elements may be provided with absorption layers for improving absorption of the incident radiation.

The circuitry may comprise a digital part for accomplishing a digital signal processing and may comprise an A/D converter (AD-converter) for converting analogue signals into digital signals, wherein the latter may be provided in plural parallel bits or as a serial bit stream.

Filtering means may be provided in the optical path or in the analogue signal path or in the digital signal path.

The housing may be of relatively good thermal conductivity. Particularly, it may have a thermal conductivity better than 20% of that of pure copper, preferably better than 50% thereof.

Further, the housing may be electrical conductive for shielding the internal circuitry against external electromagnetic radiation, this reducing its impact on the internal circuitry.

The housing may have standardized dimensions, for example, following the TO5 standard or the TO46 standard. It may also be formed as an SMD (surface mounted device).

FIG. 1 shows a sensor to which the invention may be applied. A circuit board 3 carries sensing elements 1 and circuitry 2. A base plate 6 of a housing 4-6 is pierced by terminals 7 which in turn are connected to the circuitry 2 and/or the sensing elements 1, for example by bonding, indicated by 8. The circuit board 3 may be provided on the base plate 6. In the shown embodiment, the sensor comprises only one output terminal 7a for outputting the detection signal.

FIG. 9 shows a plain view on the open sensor. On a base plate 6 of the sensor a little circuit board 3 is provide supporting a substrate 20 that carries the sensing elements 1 and the. circuitry 2, preferably formed as an ASIC. Numerals 7a to 7d symbolize the inside ends of terminals 7 reaching to the outside as shown in FIG. 1. They may at the inner end be widened up and prepared for bonding. Bonding wires 8 may go from the terminal ends to appropriate counter terminals, for example on circuitry/ASIC 2. The sensing elements 1 may also be connected to ASIC 2 via bonding connections or other kind of wiring.

91 symbolizes a temperature reference sensor sensing the temperature of a relevant part of the sensor. The relevant part may be the substrate carrying the sensing elements 1. But likewise, the temperature sensor 91 may be integrated into ASIC 2. It is also connected to circuitry 2 by appropriate means. Its output signal may be considered in evaluating the signals from the sensing elements 1.

All together, there may be provided a stack of housing base plates 6, circuit board 3, substrate 20 and sensing element 1 and circuitry 2 on said substrate 20.

The beam converging means 5 may be a lens or a Fresnel lens. Its distance D from the plane in which the sensing elements 1 are provided may be the focal length of the lens or may be offset therefrom in z-direction (towards or away from the lens) by a defined value.

In FIG. 9, 10 symbolizes the optical axis of the beam converging means 5. The sensing elements 1 may be provided symmetrically with respect to the optical axis or in a certain manner asymmetrically.

The sensing elements 1 may be provided with common mode suppression. Sensing elements for infrared radiation provide an Ac or a DC signal at their terminals. The arrangement may be such that signal components received by two sensing elements in the same way (common mode) cancel each other. This is achieved by connecting two sensing elements in series or parallel with opposing polarity, i.e. in a series connection either connecting the respective plus terminals or the respective minus terminals, and in a parallel connection connecting plus of the one to minus of the other sensing element. Then, the common mode cancels out and only focused radiation from a distinct source, hitting only one of the sensing elements, will lead to a signal because it is not cancelled out by a same, oppositely polarized signal component from the respective other sensing element. Through this, disturbing quantities such as temperature rise of the overall device or wide spread radiation sources such as surfaces heating up upon incidence sunlight, do not lead to miss-detections. The connected sensing elements may be adjacent to each other or More remote than the dimension of one sensing element.

The circuitry 2 inside the sensor is constructed such that it has a power consumption of less than 50 μW, preferably smaller than 20 μW or smaller 10 μW in operation mode. Consumed power is transformed into heat. By making the design such that the consumed electric power is small, also the obtained heating power is small. Then, the internal heating does not lead to misdetections. It has shown that heat generated by the internal circuitry itself may significantly contribute to misdetections. The sensing elements 1 usually operate on the basis of converting incident radiation into heat sensed by the sensing elements. The sensing elements cannot distinguish between heat generated by incident radiation or heat generated by nearby internal circuitry. Thus, for minimizing misdetections from heating by circuit power, circuit power is designed to be relatively small as mentioned above.

For avoiding temperature variations due to varying power consumption due to varying internal sensor operation states (e.g. standby vs. heavy computing) the design can be made such that power consumption in the various operation states (maximum power Pmax, minimum power Pmin) differs only by a predetermined amount. For example, the ration Pmax/Pmin may be lower than 3, less than 2, less than 1.5 or less than 1.2, or the difference Pmax-Pmin may be lower than 10 μW, 5 μW, 2 μW or 1 μW.

This may be achieved by appropriately designing inherent properties of the circuitry. Dedicated power consumption control means may be provided, such as a power consumption controller which may include an appropriately controlled dummy consumer for keeping power consumption above a certain level defined in relation to the maximum possible power consumption of all possible operation states. The power consumption controller may increase power consumption, e.g. in said dummy consumer or in another component when otherwise consumption is low. Through this, power consumption is relatively uniform, and in consequence internal heating power is relatively uniform, and accordingly temperature variations caused thereby are relatively low.

The circuitry 2 includes the switching signal circuitry for generating said on/off output signal or the digital output signal circuitry for providing said multiple bit serial output signal. It is schematically connected between sensing elements 1 and output terminal 7a.

The beam converging means 5 may be made of IR transparent material. It may comprise silicon or germanium as main constituent or a mixture thereof. The lens may be shaped by micromachining.

Filtering, in the optical path may be accomplished by providing filtering layers, for example on the beam converging means 5, such as providing a lens or a Fresnel lens with filtering layers. They may be shaped as anti-reflex layers or as band-pass or low pass or high pass layers or layers of selected reflectivity. Selective wavebands may be eliminated by selective reflective filter characteristics. Plural such layers them may be provided in a stacked manner for designing the desired transmission characteristics. The optical filtering may comprise 1 or 2 or 5 or more than 5 or more than 10 or more than 20 layers.

For avoiding thermal imbalance of the overall sensor, the housing of the sensor may comprise material of relatively good thermal conductivity. It may be better than 20% or better than 50% of that of pure copper. The sensor housing 4-6 may comprise a metallic cap 4 formed of the mentioned material and carrying a radiation inlet such as the converging means 5 in an appropriate manner, particularly concentrically. Through this, thermal imbalance of the sensor is reduced so that likewise misdetections from thermal imbalance are reduced.

The reflectivity of sensor-internal walls of the housing (cap) may be less than 0.5, less than 0.2 or less than 0.1, i.e. less than 50%, 20%, 10% of the incident radiation being reflected. For selected applications it may be less than 5% or less than 1%. This serves to minimize the impact of radiation entering sideways of the intended radiation path through converging means 5 and potentially finding its way to the sensing elements through internal reflection. It is quickly absorbed and does not contribute to the signal at the sensing element.

FIG. 3 shows schematically a block diagram of the circuitry provided within the housing of sensor 10. Circuitry 2 may be an ASIC (application specific integrated circuit) and may comprise an analogue part and digital part and an AD-converter. The ASIC may comprise all mentioned components and functionalities within one chip. An AD-converter may be a link between analogue components and digital components.

The analogue components may comprise some kind of amplification 33 of the signals from the sensing elements 1. Amplification factor may be chosen as required and may also be 1 or smaller than 1. Amplification may include impedance conversion for obtaining stronger signals for subsequent evaluation.

32 may be an analogue filter filtering out signal quantities untypical for the situation to be detected. It may be a low pass filter filtering out frequencies, for example, higher than 10 Hz or higher than 5 Hz or higher than 2 Hz.

If plural sensing elements 1 are provided, there may some kind of multiplexer 31 be provided for serially polling the individual elements 1 and providing their output one after another to the input of the respectively provided analogue components. Likewise, the temperature reference sensor 21 may be connected to the multiplexer 31. But likewise, it may go more or less directly through AD-conversion 34.

The mentioned components may be under control of a controller 39 provided in the digital circuit part.

The digital circuit part, indicated by 35, may comprise a memory 36 for storing program data, input data, temporary data, measurement data, history data and the like.

A processor 37 may be provided for rendering the intended main functionality, particularly for implementing the switching signal circuitry for generating an on/off output signal and/or for implementing the digital output signal circuitry for providing a multiple bit serial output signal.

For accomplishing these functionalities and generating the mentioned output signals, the processor 37 may run appropriate programs for evaluating the measured values and potentially also values input from external through one of the terminals.

When implementing the switching signal circuitry for generating and on/off output signal, the processor may compare one or more of the measured values received from AD-converter 34 with predefined or adjusted threshold values, and generate a detection signal when the threshold is exceeded. The threshold may be defined by an external input from an input terminal for defining sensitivity of the sensor. After a positive detection was found, an output signal may switch over from a first to a second state (off to on). It may be reset (to first=off state) according to predetermined criteria also implemented by processor 37. The criteria may be resetting when the measured signal disappears or resetting after a predetermined time (such as 2 seconds) or resetting after a time determined by an input signal received through one of the input terminals. The output of the processor may be given to the output terminal 7a. Its characteristics (amplitude and/or internal resistance and/or frequency and/or coding) may be such that it is suitable for immediately driving external switching components that may directly be connected to the sensor. The two states (on/off) may be reflected by different voltages. The voltage difference between the two voltages may be more than 0.2 Volts or more than 0.5 Volts or more than 1 Volt. The output resistance at the output terminal 7a may be less than 100 Ohms or less than 50, 20 or 10 Ohms.

When embodying a digitally coded, quantitative output signal circuitry, the processor 37 may again make evaluations of the measured signals coming from the AD-converter 34 which in turn received input from one or more sensing elements 1. The evaluation may be made under given criteria reflected by a program stored in memory 36. The result of the evaluations may lead to a quantitative value, for example for reflecting a temperature value. This value may be given to a Codec (coding/decoding circuit) 38 which may encode the quantitative value into a serial bit stream of a predefined coding scheme. This may be given to the output terminal 7a. By the Codec 38 the serial signal is again shaped (amplitude, bit duration, internal resistance) to be suitable for being immediately received by external (listening) components conforming to the chosen encoding scheme. Codec 38 may operate in accordance with a known coding scheme, such as binary, IIC or the like. In case of IIC a clock signal output may additionally be provided.

The sensor may be adapted to implement both a switching signal circuitry and a digital output signal circuitry in a selectable manner, selectable for example by an input signal through one of the terminals 7.

The sensor may have three terminals 7, namely one output terminal 7a and two power terminals 7b for supply voltage and 7c for ground. The output terminal 7a outputs the digital serial output signal or the switching signal mentioned above. The sensor may also have a fourth terminal 7d for an input signal. It may be a sensitivity setting signal or an on-time setting signal or an enable signal or a selection signal or a synchronization signal for synchronizing sensor-internal cycles/timings to external requirements. The sensor may also comprise more than one input terminal. It may comprise input terminals for each of the mentioned input quantities, i.e. one terminal for sensitivity setting, one terminal for on-time setting one terminal for enable setting, one input terminal for the above mentioned selection signal and one input signal for the synchronization signal.

39 designates a control section controlling the functionalities of the respective analogue and digital components. Technically, the digital circuit part 35 may have a CPU that implements at appropriate times the processor 37, the controller 39 and the Codec 38.

The controller 39 may control operation of multiplexer 31, filter 32, AD-converter 34 and of the digital components.

The Codec 38 may also be used for decoding coded input data from one of the input terminals.

The enable input may receive a signal from a light sensing device so that outputting an on/off output signal of a switching signal circuitry is avoided when presence of light is already detected. This avoids operation, for example, during daytime.

Sensitivity of the sensor may be defined through mask programming on chip level, preferably on the ASIC. The circuitry 2 may comprise structures that may permanently be modified for obtaining a desired sensitivity. This may be done in the analogue signal part or in the digital signal part. It is indicated by numeral 40 in FIG. 3 and is, shown there as a part of the analogue branch, influencing operation of filter 32 and/or amplifier 33. But likewise, it may be provided in the digital circuit part 35.

In its external appearance, the sensor may be dimensioned according to certain standards, such as TO5 or TO46. The sensor may also be formed as a surface mount device (SMD) having contact areas or contact bumps on one of the surfaces thereof.

Itemization of features of the second invention:

Item 1. A radiation sensor (10) comprising one or more radiation sensing elements (1) providing an electric signal in dependence of incident radiation,

a housing (4-6) confining the sensing element and permitting incidence of radiation from outside onto the sensing element,

plural terminals (7) for supplying electrical power to the sensor and for outputting a sensor output signal, and

circuitry (2) receiving the electric signal of the sensing element and providing the output signal in accordance with the electric signal of the sensing element,

characterized in that

the circuitry comprises a switching signal circuitry for generating an on/off output signal for a switchable component external to the sensor and/or a digital output signal circuitry for providing a multiple bit serial output signal, and

the sensor has one output terminal (7a) for outputting the on/off output signal or the multiple bit serial output signal.

Item 2. The sensor of item 1 comprising one or more input terminals (7d) for receiving one or more of an enable signal, a sensitivity setting signal, a switching signal duration setting signal or a synchronization signal.

Item 3. The sensor of item 1 or 2, wherein the power consumption of the circuitry provided inside the housing is smaller than 50 μW, preferably smaller than 20 μW or smaller than 10 μW.

Item 4. The sensor of one of the preceding items having four terminals, namely two power terminals (7b,c), one signal output terminal (7a) and one input terminal (7d).

Item 5. The sensor of one of the preceding items wherein the switching signal circuitry is adapted to generating the on/off output signal of a predetermined duration or of a duration in accordance with a received input signal.

Item 6. The sensor of one of the preceding items, comprising an A/D converter for converting an analog quantity into a serial or parallel digital quantity, wherein the A/D converter input may be multiplexable amongst the electrical signal of the sensing element or a signal derived therefrom and at least one input signal input through at least one of the input terminals.

Item 7. The sensor of one of the preceding items, comprising a temperature reference element connected to the circuitry for detecting a reference temperature of the sensor element.

Item 8. The sensor of one of the preceding items, wherein the sensing element is or comprises a thermopile, a bolometer or a pyroelectric sensing element, and/or is adapted to detecting infrared radiation, preferably in a range of wavelength of 2 μm to 20 μm.

Item 9. The sensor of one of the preceding items, comprising a radiation converging means (5) converging incident radiation in a convergence plane, and plural sensing elements arranged in a defined relationship with reference to said plane.

Item 10. The sensor of one of the preceding items, wherein one or plural pairs of polar sensing elements are provided, the sensing elements of the pairs being connected for delivering a common electric signal with common mode suppression.

Item 11. The sensor of one of the preceding items, wherein the circuitry comprises an integrated circuit, preferably an ASIC, comprising preferably an A/D converter (2b) for analog-digital converting signals, particularly one or more of an electric signal generated in accordance with an electric signal of a sensing element or an analog input signal, and comprising a digital signal processing part (2c), which may comprise one or more of

a memory part for storing one or more of input data, program data, measured data, intermediate data.

coding and/or decoding means for encoding data to be output and/or for decoding input data,

multiplexing commanding means for controlling connection of input and/or of output of the A/D converting means and/or of the coding and/or decoding means,

computing means for processing signals derived from the output of the sensing element, wherein the ASIC may further comprise an analog circuit part (2a) that comprises one or more of

amplification means for amplifying the electric signal from the sensing element,

impedance converting means connectable to a sensing element,

filtering means,

synchronization means.

Item 12. The sensor of one of the preceding items, comprising a radiation converging means (5), preferably formed as a part of the housing, and formed as a continuous, preferably spherical lens or as a Fresnel lens, preferably made of silicon and/or germanium as main constituents.

Item 13. The sensor of one of the preceding items, comprising filtering means for filtering the radiation incident on the sensing elements, preferably formed as one or a plurality of layers on a radiation converging means as an anti-reflex layer and/or a band pass layer.

Item 14. The sensor of one of the preceding items, wherein the housing comprises a cap made of material of electrical conductivity and/or of a thermal conductivity of at least 20% or at least 50% of that of pure copper.

Item 15. The sensor of one of the preceding items, formed as an SMD or having a housing of standardized configuration, preferably TO5 or TO46.

Item 16. The sensor of one of the preceding claims, comprising power consumption control means, particularly adapted to controlling power not to fall below a certain value, the certain value preferably being defined in relation to a maximum possible power consumption.

Features described in this specification shall be deemed combinable with each other as far as their combination is not excluded by technical reasons.

Likewise, the features described with reference to prior art may also be used in combination with features of the invention, as far as not being in contradiction thereto.

1. A radiation sensor (10) comprising
plural radiation sensing elements (1) arranged along an arrangement line and providing respectively an electric signal in dependence of respectively incident radiation,
radiation converging means having an optical axis for converging incident radiation towards the sensing elements, and
circuitry (2) receiving the electric signal of the sensing elements and providing an output signal in accordance with the electric signals of the sensing elements,
characterized in that
the midpoint of the arrangement line is offset against the optical axis of the converging means (5).

2. A radiation sensor (10), preferably formed in accordance with claim 1, comprising
plural radiation sensing elements (1) arranged along an arrangement line and providing respectively an electric signal in dependence of respectively incident radiation,
radiation converging means having an optical axis for converging incident radiation towards the sensing elements, and
circuitry (2) receiving the electric signal of the sensing elements and providing an output signal in accordance with the electric signals of the sensing elements,
characterized in that
at least some of the sensing elements have different sizes of their sensitive portions compared to each other, preferably different lengths of their effective sensitive area in a dimension along the arrangement line.

3. A radiation sensor (10), preferably formed in accordance with one claim 1, comprising
plural radiation sensing elements (1) arranged along an arrangement line and providing respectively an electric signal in dependence of respectively incident radiation,
radiation converging means having an optical axis for converging incident radiation towards the sensing elements, and
circuitry (2) receiving the electric signal of the sensing elements and providing an output signal in accordance with the electric signals of the sensing elements,
characterized in that
at least some of the sensing elements have different relative sensitivity compared to each other, preferably made by different constructions of the sensing portions or different provision of influencing layers, particularly absorption layers or reflection layers, on said sensing elements.

4. A radiation sensor (10), preferably formed in accordance with claim 1, comprising
plural radiation sensing elements (1) arranged along an arrangement line and providing respectively an electric signal in dependence of respectively incident radiation,
radiation converging means having an optical axis for converging incident radiation towards the sensing elements, and
circuitry (2) receiving the electric signal of the sensing elements and providing an output signal in accordance with the electric signals of the sensing elements,
characterized in that
two or more pairs of adjacent sensing elements have a different pitch.

5. A radiation sensor (10), preferably formed in accordance with claim 1, comprising
one sensing element or plural radiation sensing elements (1) arranged along an arrangement line and providing respectively an electric signal in dependence of respectively incident radiation, radiation converging means having an optical axis for converging incident radiation towards the sensing elements, and
circuitry (2) receiving the electric signal of the sensing elements and providing an output signal in accordance with the electric signals of the sensing elements,
characterized in that
the converging means comprises one or more converging sections for converging radiation and one or more bending sections for bending radiation, the converging section and the bending section preferably being formed integrally.

6. The sensor of claim 1, wherein the arrangement line is a straight line intersecting the optical axis.

7. The sensor of claim 1, wherein the converging means comprises a lens part that may be provided as a part of a housing confining the sensing elements, wherein the lens part may be a spherical lens or a lens with correcting structures.

8. The sensor of claim 1, wherein the arrangement line has a longer part on the one side of the optical axis and a shorter part on the 30 other side of the optical axis, wherein
the size of the sensing elements decreases from an outmost sensing element on the longer part towards a sensing element close to the midpoint, and/or
the sensitivity of the sensing elements increases or decreases from an outmost sensing element on the longer part towards a sensing element close to the midpoint, and/or
the pitch decreases from an outmost sensing element on the longer part towards a sensing element close to the midpoint.

9. The sensor of claim 1, comprising plural further sensing elements, preferably arranged along one or more further arrangement lines.

10. The sensor of claim 1, wherein the sensing elements are sensitive for infrared radiation, and preferably being covered by and influencing layer for increasing absorption of incident radiation.

11. The sensor of claim 1, wherein the circuitry comprises means for individually weighting the output signal from each of the sensing elements.

12. The sensor of claim 1, comprising an outside marker for indicating the arrangement of the inside arrangement line.

13. The sensor of claim 1, comprising terminals provided at a sensor surface having a predetermined angle with respect to the optical axis, the angle being 0° or 90° or a value in between.

14. The sensor of claim 1, wherein the circuitry comprises an integrated circuit, preferably an ASIC, comprising preferably an A/D converter (2b) for analog-digital converting signals, particularly one or more of an electric signal generated in accordance with an electric signal of a sensing element or an analog input signal, and comprising a digital signal processing part (2c), which may comprise one or more of
a memory part for storing one or more of input data, program data, measured data, intermediate data.
coding and/or decoding means for encoding data to be output and/or for decoding input data,
multiplexing commanding means for controlling connection of input and/or of output of the A/D converting means and/or of the coding and/or decoding means,
computing means for processing signals derived from the output of the sensing element, wherein the ASIC may further comprise an analog circuit part (2a) that comprises one or more of
amplification means for amplifying the electric signal from the sensing element,
impedance converting means connectable to a sensing element,
filtering means.
